(19) United States
(12) Patent Application Publication
(10) Pub. No.: US 2026/0364898 A1
(43) Pub. Date: Nov. 19, 2026

(54) MOLD APPARATUS FOR MANUFACTURING OF DEPLOYABLE THERMOPLASTIC BOOM STRUCTURE FOR SPACE APPLICATIONS

(71) Applicant: WILDSTAR, LLC, Arlington, TX (US)

(72) Inventor: Arthur Schlothauer, Palo Alto, CA (US)

(73) Assignee: WILDSTAR, LLC, Arlington, TX (US)

(21) Appl. No.: 19/679,272

(22) Filed: May 15, 2026

Related U.S. Application Data
(60) Provisional application No. 63/807,028, filed on May 16, 2025.

(51) Int. Cl. B29C 70/46; B64G 1/22; B29K 105/08; B29L 31/30

(52) U.S. Cl. CPC B29C 70/46; B64G 1/2225; B29K 2105/0827; B29L 2031/3097

(57) ABSTRACT

The disclosed technology is generally directed to an apparatus including top and bottom molds. The top mold includes a bottom surface including a protrusion, a first alignment element, and a second alignment element complimentary to the first alignment element. The protrusion has a first shape to mold a first half shell of a deployable boom structure in a furlable shape. A shape of the bottom mold is complimentary to a shape of the top mold. The bottom mold includes a top surface including a depression, a third alignment element, and a fourth alignment element complimentary to the third alignment element. The depression has a second shape complimentary to the first shape to mold the first half shell of the deployable boom structure in a furlable shape. The fourth alignment element is same as the first alignment element. The third alignment element is same as the second alignment element.

### RELATED APPLICATIONS

This application claims the benefit of U.S. Provisional Application Number 63/807,028, filed on May 16, 2025, which is incorporated herein by reference in its entirety.

### TECHNICAL FIELD

This disclosure is directed to manufacturing of a deployable boom structure, and more particularly, to a method and apparatus for continuous and automated manufacturing of an ultra-long thin-walled deployable thermoplastic boom structure for space applications.

### BACKGROUND

Satellites have become important tools for various applications, including communication, Earth observation, navigation, and scientific research. Spacecraft systems, which include earth and planetary orbiting satellites and deep space probes, often incorporate deployable systems including deployable structures, deployable solar arrays, deployable antennas, and other deployable subsystems. Once the spacecraft is in space, the spacecraft is typically configured for use by deploying an assembly of extendable deployable components. For example, the assembly of extendable components may include an extendable boom assembly that may be utilized as a platform for sensors, such as a magnetometer or electric field sensor, or other components of the spacecraft.

The large deployable structures may be widely utilized in spacecraft structures to expand a variety of large apertures, solar power systems, solar sails, and other structures, which may be stowed in a compact volume of a launch vehicle and may be deployed in large surfaces in space. The conventional methods for manufacturing the deployable boom structure utilizing thermoset composite materials have a throughput of one to two booms a day due to large manual labor and slow curing of thermoset resins. The conventional methods may require large molds and ovens or autoclaves that increases investment over-proportionally with a boom length.

Therefore, in light of the foregoing, there is a need for a technical solution to overcome the challenges associated with the conventional methods for manufacturing the deployable boom structure.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an embodiment of the present disclosure may provide an apparatus comprising a top mold and a bottom mold. The top mold comprises a bottom surface. The bottom surface comprises a protrusion, a first alignment element, and a second alignment element. The protrusion having a first shape to mold a first half shell of a deployable boom structure in a furlable shape. A shape of the second alignment element is complimentary to a shape of the first alignment element. The first and second alignment elements are positioned at the same distance from a center of the protrusion on opposite sides of the protrusion. A shape of the bottom mold is complimentary to a shape of the top mold. The bottom mold comprises a top surface. The top surface comprises a depression, a third alignment element, and a fourth alignment element. The depression having a second shape to mold the first half shell of the deployable boom structure in a furlable shape. The second shape is complimentary to the first shape. A shape of the fourth alignment element is complimentary to a shape of the third alignment element and the shape of the second alignment element and same as the shape of the first alignment element. A shape of the third alignment element is complimentary to the shape of the first alignment element and same as the shape of the second alignment element. The third and fourth alignment elements are positioned at the same distance from a center of the depression on opposite sides of the depression.

Implementations may include one or more of the following features. In some implementations, the first shape corresponds to one of a semi-lenticular shape, a semi-circular shape, and a half a triangular reliable and collapsible (TRAC) shape. The second shape corresponds to an inverted semi-lenticular shape, an inverted semi-circular shape, and an inverted half a TRAC shape.

In some implementations, the shape of the first alignment element and the shape of the fourth alignment element corresponds to one of a trapezoidal shape, a semi-circular shape, and a triangular shape. The shape of the second alignment element and the shape of the third alignment element corresponds to one of an inverted trapezoidal shape, an inverted semi-circular shape, and an inverted triangular shape.

In some implementations, the first alignment element corresponds to a ridge on the bottom surface of the top mold. The second alignment element corresponds to a groove on the bottom surface of the top mold.

In some implementations, the third alignment element corresponds to a groove on the top surface of the bottom mold. The fourth alignment element corresponds to a ridge on the top surface of the bottom mold.

In some implementations, the protrusion on the bottom surface of the top mold is configured to engage with the depression on the top surface of the bottom mold to mold the first half shell of the deployable boom structure in a furlable shape.

In some implementations, the first alignment element is configured to engage with the third alignment element to form a first alignment notch of the first half shell of the deployable boom structure. The second alignment element is configured to engage with the fourth alignment element to form a second alignment notch of the first half shell of the deployable boom structure. The first alignment notch is complimentary to the second alignment notch. The first and second alignment notches are positioned at the same distance from a center of the first half shell of the deployable boom structure on opposite sides of the first half shell of the deployable boom structure.

In some implementations, the top and bottom molds are configured to receive a thermoplastic fabric between the top and bottom molds and mold the thermoplastic fabric into the furlable shape based on the pressure applied on the first and second molds.

In some implementations, the top mold and the bottom mold comprise a first plurality of holes and a second plurality of holes to receive cartridge heaters to heat the top and bottom molds, respectively, for molding the deployable boom structure.

In some implementations, the top and bottom molds are configured to mold a second half shell of the deployable boom structure.

In some implementations, the second half shell of the deployable boom structure corresponds to an inverted version of the first half shell of the deployable boom structure.

In some implementations, a shape of the first half shell of the deployable boom structure corresponds to one of a semi-lenticular shape, a semi-circular shape, and a half a TRAC shape and a shape of the second half shell of the deployable boom structure corresponds to one of an inverted semi-lenticular shape, an inverted semi-circular shape, and an inverted half a TRAC shape, thereby a shape of the deployable boom structure corresponds to one of a lenticular shape, a circular shape, and a TRAC shape respectively.

In some implementations, the deployable boom structure corresponds to a deployable thermoplastic boom structure.

In another aspect, an embodiment of the present disclosure may provide a deployable thermoplastic boom structure. The deployable thermoplastic boom structure comprises a first half shell and a second half shell. The first half shell is having a furlable shape. The first half shell comprises a first curved region, a first alignment notch, and a second alignment notch. A shape of the second alignment notch is complimentary to a shape of the first alignment notch. The first and second alignment notches are positioned at the same distance from a center of the first curved region on opposite sides of the first curved region. The second half shell is having a furlable shape. A shape of the second half shell is complimentary to a shape of the first half shell. The second half shell comprises a second curved region, a third alignment notch, and a fourth alignment notch. A shape of the fourth alignment notch is complimentary to a shape of the third alignment notch and the shape of the second alignment notch and same as the shape of the first alignment notch. A shape of the third alignment notch is complimentary to the shape of the first alignment notch and same as the shape of the second alignment notch. The third and fourth alignment notches are positioned at the same distance from a center of the second curved region on opposite sides of the second curved region. The first and third alignment notches are welded together and the second and fourth alignment notches are welded together to form the deployable thermoplastic boom structure.

In some implementations, the first curved region has one of a semi-lenticular shape, a semi-circular shape, and a half a triangular reliable and collapsible (TRAC) shape. The second curved region has one of an inverted semi-lenticular shape, an inverted semi-circular shape, and an inverted half a TRAC shape.

In some implementations, the shape of the first alignment notch and the shape of the fourth alignment notch corresponds to one of an inverted trapezoidal shape, an inverted semi-circular shape, and an inverted triangular shape. The shape of the second alignment notch and the shape of the third alignment notch corresponds to one of a trapezoidal shape, a semi-circular shape, and a triangular shape.

In some implementations, the second half shell of the deployable thermoplastic boom structure corresponds to an inverted version of the first half shell of the deployable thermoplastic boom structure.

In some implementations, a shape of the deployable boom structure corresponds to one of a lenticular shape, a circular shape, and a TRAC shape respectively.

Further aspects, features, applications and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIGS. 1A, 1C, and 1E are diagrams illustrating a top view of thermoset boom designs utilized in conventional deployable boom structure;

FIGS. 1B, 1D, and 1F are diagrams illustrating a cross-sectional view of the thermoset boom designs utilized in conventional deployable boom structure;

FIGS. 2A-2C, collectively, illustrate a triaxial braid fabric in which aspects of the technology may be employed;

FIG. 3 is a simplified diagram illustrating a system for manufacturing the deployable thermoplastic boom structure in which aspects of the technology may be employed;

FIG. 4A is a simplified diagram illustrating a mold which may be utilized for manufacturing the deployable boom structure in which aspects of the technology may be employed;

FIG. 4B is a simplified diagram illustrating a cross-sectional side view of the mold of FIG. 4A in which aspects of the technology may be employed;

FIG. 4C illustrates a zoomed view of the mold of the FIG. 4B in which aspects of the technology may be employed;

FIG. 5A is another simplified diagram illustrating a system for manufacturing the deployable thermoplastic boom structure in which aspects of the technology may be employed;

FIG. 5B is another simplified diagram illustrating the welding system for welding a first half shell and a second half shell of the deployable thermoplastic boom structure generated by a continuous compression molding (CCM) system in which aspects of the technology may be employed;

FIG. 6 illustrates the deployable thermoplastic boom structure in which aspects of the technology may be employed;

FIGS. 7A and 7B are diagrams illustrating implementation of the deployable thermoplastic boom structure for a satellite system in which aspects of the technology may be employed; and

FIGS. 8A-8C are diagrams illustrating deploying of the deployable thermoplastic boom structure for the satellite system in which aspects of the technology may be employed.

In the drawings, similar reference numerals refer to similar parts throughout the drawings unless otherwise specified. These drawings are not necessarily drawn to scale.

### DETAILED DESCRIPTION

Technologies are provided for manufacturing a deployable boom structure. Technologies are also provided for continuous and automated manufacturing of an ultra-long thin-walled deployable thermoplastic boom structure for space applications. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of security concepts that are appliable to the exemplary embodiments will be provided.

### Deployable composite spacecraft boom

Large spacecraft structures may rely on the deployable composite spacecraft booms, which may support solar sails, antennas, and optical elements. The deployable composite spacecraft booms may require to be stiff and strong enough to withstand loading in space to pre-tension membranes and may fail to deform excessively during maneuvers. The deployable composite spacecraft booms may require to be thin and strong to withstand the high stresses that may be created when packaging in the limited volume of a spacecraft. The deployable composite spacecraft booms may be typically flattened and rolled around cylindrical hubs and further expand in space once unrolled by a deployer. The deployable composite spacecraft booms may utilize the stored elastic energy of the composite to return to an initial shape of the deployable composite spacecraft booms.

Conventional methods may utilize carbon fiber reinforced thermoset polymer materials as a raw material for manufacturing the deployable composite spacecraft booms. For manufacturing thermoset raw materials dry fibers may be aligned and are spread out into a sheet. The sheet of dry fiber may be further sandwiched between liquid polymer films of thermoset composites like epoxy. The thickness of the thermoset raw materials may be controlled by varying the width of the dry fiber distribution. The dry fiber is coated with a polymer that protects the dry fiber against breaking and may provide adhesion to the epoxy, thereby facilitating the spreading of dry fiber and manufacturing thin thermoset raw material required for the deployable composite spacecraft booms.

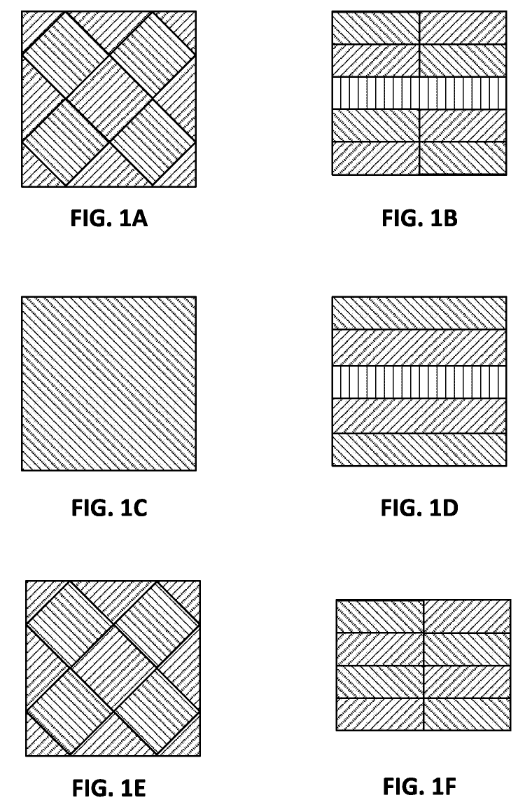

FIGS. 1A, 1C, and 1E are diagrams illustrating a top view of thermoset boom designs utilized in conventional deployable boom structure. FIGS. 1B, 1D, and 1F are diagrams illustrating a cross-sectional view of the thermoset boom designs utilized in conventional deployable boom structure. The deployable spacecraft booms may include multiple layers of carbon fiber reinforced polymers that provide stiffness and strength in all directions. Longitudinal fibers, which may follow the boom axis may increase bending stiffness of the deployable spacecraft booms. Fibers oriented to 45 degrees may increase robustness when flattening and torsional stiffness. A composite designer may aim to create a balanced and symmetric arrangement of different plies (i.e. layers with a certain fiber angle) that facilitates bending of the deployable spacecraft booms without twisting and may fail to distort when subjected to temperature gradients in space.

When utilizing unidirectional plies alone that may include one fiber direction, a deployable spacecraft boom layup may include at least four to five plies to create a balanced and symmetric arrangement as shown in FIGS. 1C and 1D. Each thicker ply may add complexity to produce a thin deployable spacecraft boom that may flatten and roll. Utilization of plain weaves of fibers may facilitate combining two fiber angles in one single ply as shown in FIGS. 1E and 1F.

Modern spreading techniques may allow thermoset composite materials to be woven achieving very thin plain weave “checkerboard” patterns. For the thermoset composite materials, the combination of weave and unidirectional plies may allow the deployable spacecraft boom that may be balanced and symmetric by utilizing three plies as shown in FIG. 1A and FIG. 1B.

### Technical Problem with Conventional manufacturing of deployable boom structure.

Conventional methods utilizing the carbon fiber reinforced thermoset polymer materials may have ply thickness ranging between 30 micrometers to 70 micrometers. The deployable boom structure may be cured in an autoclave or large ovens that may include expensive long molds and may require multiple hours based on a resin utilized, thereby limiting production rates of the deployable boom structures. The production rates may be limited to one to two deployable boom structures per day due to large manual labor and slow curing thermoset resins.

Conventional methods that may propose thermoplastic booms substituting thermoset booms may rely on very thin thermoplastic raw materials, which may be inefficient and adding complexity to achieve at large scale. The thermoplastic raw materials may rely on different types of fiber surface treatment to enhance interface with polymers, which restricts producing thin thermoplastic raw materials. Currently, thickness of commercially available thermoplastic may range between 70 micrometers to 80 micrometers and thickness of thermoset materials may be scaled down to 15 micrometers.

Conventional methods utilizing the thermoset materials in combination with a continuous compression molding process may be limited in throughput and quality due to slow curing of thermoset resins. Fast curing the thermoset resins may exhibit weaker structural performance as compared to thermoplastic and an exothermic reaction may be difficult to control.

The conventional method utilizing triaxial braids produced from thermoplastic in compression molding applications may provide better structural performance and drapability as compared to unidirectional plies or weaves but may produce thicker structures that may have applications in aircraft panels. The conventional method utilizes thicker input materials and may aim more towards manufacturability and stiff structural performance restricting the utilization for foldable structure which may be important for spacecraft boom structures.

The conventional methods for manufacturing spacecraft booms that utilizes thermoplastic may produce the spacecraft booms of very short length due to limited press dimensions and limited raw material availability. The raw material may be custom made and lacks scalability for large structures.

In accordance with the disclosed embodiments, an apparatus and a method are provided to manufacture a deployable thermoplastic boom structure for space applications utilizing a continuous compression molding system at low thickness for deployable structures in space and high manufacturing rate. The method may facilitate high-rate and automated large-scale manufacturing of thin and large composite spacecraft structures. The composite spacecraft structures may be further utilized in constellation of deployable satellites that may facilitate multiple satellites to be built in a short amount of time. The manufacturing method may utilize thin braids of impregnated unidirectional thermoplastic tape to achieve symmetric composite layup architectures that utilizes one of single ply or double plies, thereby achieving minimal thickness, axial stiffness, and off-axis strength.

The off-axis strength may facilitate the spacecraft thermoplastic boom structure to be flattened and rolled to be packaged in the satellite. The architectures may be coupled with continuous compression molding (CCM) techniques, which facilitates thin, continuous cross-sections of spacecraft booms at infinite length, and large manufacturing rates of foldable and low thermal expansion spacecraft booms eliminating the requirement for large ovens.

Comparing to the conventional thermoset spacecraft booms that utilize a combination of weaves and unidirectional layers in balanced and symmetric layups, the manufacturing method may utilize a single ply that may be inherently symmetric and balanced. An overall shell of the deployable thermoplastic boom structure may eliminate the requirement for multiple layers for achieving symmetry facilitating utilization of thicker input material for the triaxial braid as compared to the input material utilized in the conventional methods. Utilization of thicker thermoplastics may facilitate the continuous manufacturing of the raw material and mitigates the impact of the limited availability of raw material in the conventional methods. The thermoplastic input material may have ability to be molten and reshaped in short span of time utilizing continuous compression molding process.

Utilization of thermoplastic triaxial braids may facilitate rapid manufacturability of ultra-light weight thermoplastic spacecraft booms that may compete with performance of the thermoset booms. Boom aerial weights of 170 gram per meter square and lower may be achievable by utilizing thermoplastic triaxial braids as the braided architecture is inherently symmetric and balanced. Additionally, single strands of zero degrees fiber may be removed that further reduces the fiber aerial weight with a reduction in axial stiffness. Single strands of zero degrees fiber may be added to increase stiffness without incorporating a whole ply, thereby maintaining low fiber aerial weight and providing flexibility in performance optimization.

Utilization of thermoplastic may help to increase the throughput of the deployable thermoplastic boom structure to fifteen meters per hour that may allow to manufacture twenty-four times more booms per day as compared to the conventional methods. Utilization of continuous compression molding may eliminate hand labor. The manufacturing method may facilitate unwinding the raw material continuously eliminating prior hand labor during manufacturing ensuring time and cost efficiency.

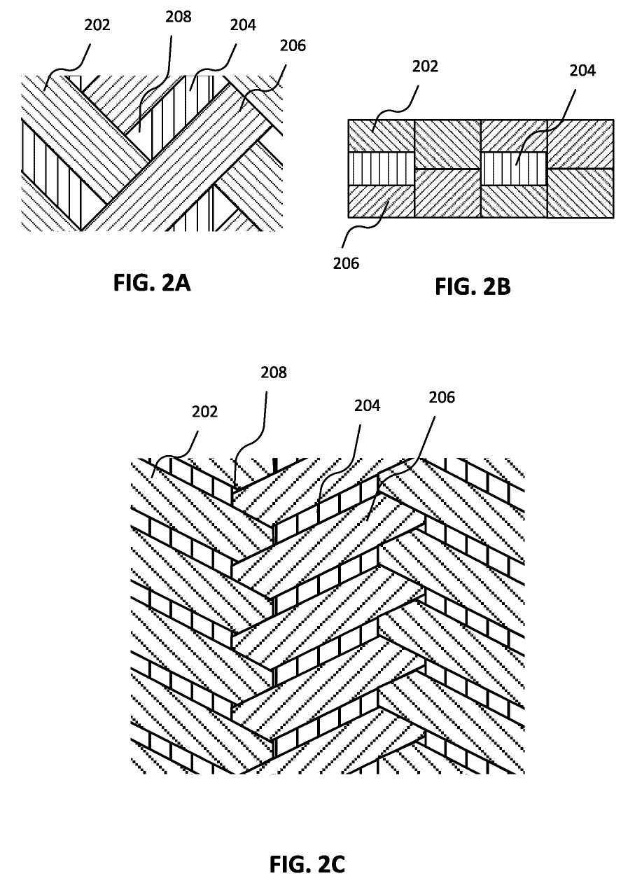

Having given this description of the apparatus and the method to manufacture the deployable thermoplastic boom structure that can be applied within the context of the present disclosure, technologies will now be described for the apparatus and the method to manufacture the deployable thermoplastic boom structure for space applications using the continuous compression molding system with reference to FIGS. 2A-8C.

Thermoplastic materials are emerging as one of the most promising categories of aerospace materials due to desirable properties of the thermoplastic materials. Good impact resistance, good damage tolerance, low damage propagation rate, good environmental resistance, high service temperature, repairability by remelting, and short production-cycle times are the important advantages of the thermoplastic composites. Thermoplastic materials may provide an increased material quality and a higher economic efficiency with respect to manufacturing and processing.

The thermoplastic material may become soft upon heating and may harden upon cooling. The thermoplastic materials may be molten and re-shaped multiple times due to melting ability of a polymer. The manufacturing rate of a thermoplastic may be based on how fast the thermoplastic is melted and cooled which makes the thermoplastic very useful for very fast stamping processes which utilize hot tools to melt and apply pressure. However, high performing thermoplastic may require very large temperatures to melt. For example, a poly aryl ether ketone (LMPAEK), which is the thermoplastic that may melts at 305 degrees Celsius and a thermoset may cure at a temperature ranging between 120 degree Celsius to 170 degrees Celsius.

The large temperatures may limit the application of standard sizing to the surface of the carbon fiber, which pose a challenge to spread out and create very thin raw material as fibers break during spreading. Large spacecraft booms may exceed 3 meters in length, adding complexity to find hot presses that may stamp the thermoplastic materials with the micrometer level thickness precision. However, ultra-long continuous cross sections may be produced utilizing a continuous compression molding system, which facilitates thermoplastic to be utilized for spacecraft booms with very thin input thermoplastic input materials.

For thermoplastic raw materials surface coating a fiber may be inapplicable that may affect spreading of the fiber as the fiber may be brittle and limits the thickness of the thermoplastic raw materials. The missing surface coating (i.e., sizing) on the fibers may prevent the fibers to be spread or woven prior to impregnation of the fibers with polymers, thereby limiting the utilization of carbon fiber plain weaves with thermoplastic matrix.

However, by utilizing unidirectional materials that may be impregnated with polymer and may be braided further may allow a combination of weave and unidirectional plies for thermoplastic composites and the deployable spacecraft booms utilizing thermoplastics. The booms may rely on thicker (80 micrometers per ply for unidirectional, 160 micrometers for weave) input strands, which may limit the foldability of a boom and the combination of weave and unidirectional plies may result in heavier booms.

FIGS. 2A-2C, collectively, illustrate a triaxial braid fabric in which aspects of the technology may be employed. In an embodiment, to overcome the limitation of thicker input strands, the triaxial braid fabric as shown in FIGS. 2A-2C that may include all fiber angles in a symmetric fashion within one single ply may be utilized. In another embodiment, one of a unidirectional braid and a biaxial braid may be utilized. Triaxial braid is a braiding pattern that may facilitate to make thin structures by utilizing the thicker input strands.

In an embodiment, the triaxial braid fabric may correspond to a fabric having a braided pattern that utilizes a braid of impregnated strand. The impregnated strand may correspond to impregnated unidirectional thermoplastic tape. The impregnated unidirectional thermoplastic tape may correspond to at least one of a poly aryl ether ketone (PAEK), a polyphenylene sulfide (PPS), a polyetherimide (PEI), and a polyimide (PI). In an embodiment, the impregnated unidirectional thermoplastic tape may correspond to combination of low melting poly aryl ether ketone (LMPAEK) and standard Modulus (such as T700G), Intermediate modulus (such as IMS65) or Intermediate Plus modulus (such as T1100G) fibers with continuous sheets for unidirectional plies and tapes for braids and weaves that may be one-fourth of an inch. In various other embodiments, the tapes for braids and weaves may range between one-eight of an inch to one inch.

In an embodiment, the process for producing triaxial braids with different tape orientations (e.g., ±30°, ±45°, or ±60° relative to the axial direction) may be implemented using circular over braiding, flat triaxial braiding, 3D triaxial braiding, multi-layer stacking, manual or semi-automated lay-up, and hybrid tape winding with braiding.

The braid of impregnated unidirectional thermoplastic tape may include a first tape 202 having a first orientation, a second tape 204 having a second orientation different than the first orientation, a third tape 206 having a third orientation different than the first and second orientations. The third orientation may be opposite of the first orientation. In an exemplary embodiment, the first tape 202 may have the first orientation that may correspond to +45 degrees, the second tape 204 may have the second orientation that may correspond to zero degrees, and the third tape 206 may have the third orientation that may correspond to -45 degrees.

In another exemplary embodiment, the first tape 202 may have the first orientation that may correspond to +60 degrees, the second tape 204 may have the second orientation that may correspond to zero degrees, and the third tape 206 may have the third orientation that may correspond to -60 degrees. In yet another exemplary embodiment, the first tape 202 may have the first orientation that may correspond to +30 degrees, the second tape 204 may have the second orientation that may correspond to zero degrees, and the third tape 206 may have the third orientation that may correspond to -30 degrees.

The first through third tapes 202,204,206 may be braided together to form the braid of impregnated unidirectional thermoplastic tape. The first through third tapes 202, 204, 206 may be braided together such that an architecture of the braid of impregnated unidirectional thermoplastic tape may include a first portion having a first layer of the first tape 202, a second layer of the second tape 204, and a third layer of the third tape 206. A second portion having a first layer of the first tape 202 and a second layer of the third tape 206. A third portion having a first layer of the third tape 206, a second layer of the second tape 204, and a third layer of the first tape 202. A fourth portion having a first layer of the third tape 206 and a second layer of the first tape 202.

In an embodiment, the first portion may have the first tape 202 on the top, the third tape 206 at bottom, and the second tape 204 sandwiched between the first tape 202 and the third tape 206. The second portion may have the first tape 202 on the top and the third tape 206 at bottom. The third portion may have the third tape 206 moving from bottom in the first portion and the second portion to top in the third portion, the first tape 202 moving from top in the first portion and the second portion to bottom in the third portion, and the second tape 204 sandwiched between the third tape 206 and the first tape 202. The fourth portion may have the third tape 206 moving from bottom in the first portion and the second portion to the top in the third portion and the fourth portion and the first tape 202 moving from top in the first portion and the second portion to the bottom in the third portion and the fourth portion.

In an embodiment, the architecture of the braid of impregnated unidirectional thermoplastic tape may include gaps that may correspond to triangular gaps 208. The braids may be very narrow as shown in FIGS. 2A and 2B and in specific locations within the braid creating the triangular gaps 208 and overlaps, thereby reducing an aerial weight of the material and spacecraft boom mass. The braids may form a continuous sheet of boom when compressed in a press such that the triangular gaps 208 may be filled. For example, an input material having thickness of 80 micrometers may be compressed in a press to generate a sheet having thickness of 166 micrometers with all required fiber angles that may be thinner as compared to the combination of weave and unidirectional plies which may have thickness of 384 micrometers for symmetric and balanced layup and the pure unidirectional ply combination ([+45/-45/0/-45/+45]) which may have thickness of 400 micrometers. The tri-axial braid may allow adding more strands of 0-degree (longitudinal) strips that increase the stiffness gradually, which may facilitate more design freedom. The utilization of the triaxial braid fabric may facilitate continuous unwinding from a reel, thereby facilitating continuous manufacturing processes such as the CCM techniques.

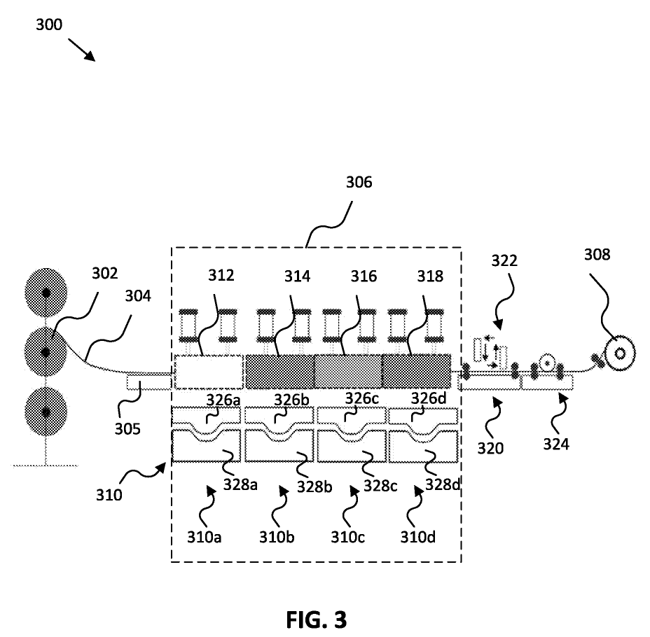

FIG. 3 is a simplified diagram illustrating a system 300 for manufacturing the deployable thermoplastic boom structure in which aspects of the technology may be employed. The system 300 includes a first reel 302, a triaxial braid fabric 304, an edge aligner 305, a continuous compression molding (CCM) system 306, and a second reel 308. The triaxial braid fabric 304 may be wound on the first reel 302. The triaxial braid fabric 304 may be fed continuously through the CCM system 306 by continuously unwinding the triaxial braid fabric 304 wounded on the first reel 302. The first reel 302 may allow for smooth and continuous unwinding of the triaxial braid fabric 304. Further, the edge aligner 305 may align edges of the triaxial braid fabric 304 to properly align and guide the triaxial braid fabric 304 through one or more zones of the CCM system 306.

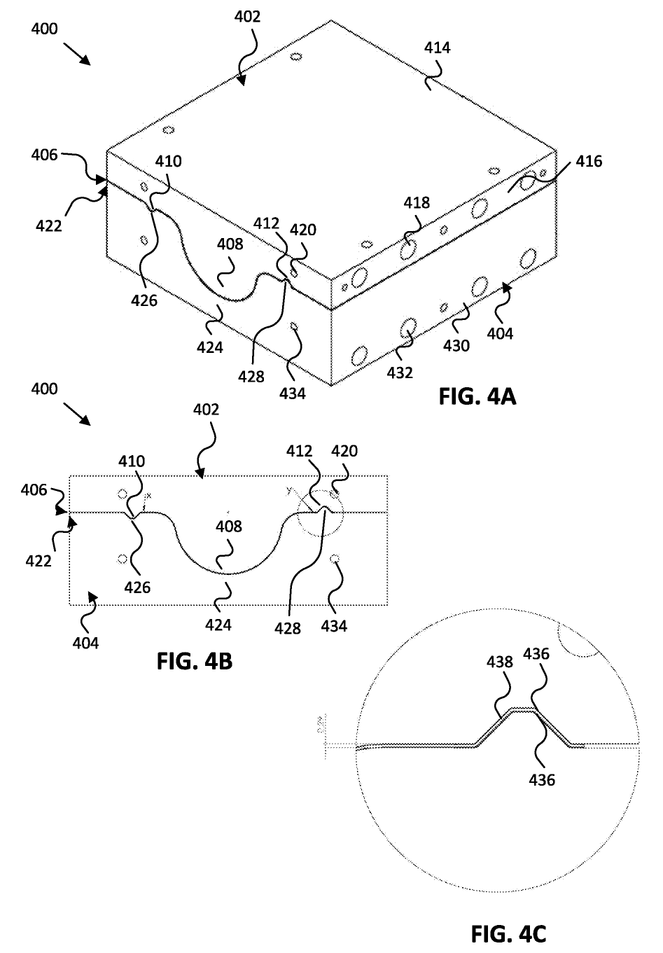

The CCM system 306 may be configured to receive the triaxial braid fabric 304 from the first reel 302. The CCM system 306 may include a plurality of molds 310, a preforming zone 312, a heating zone 314, a crystallizing zone 316, a cooling zone 318, a pulling zone 320, a holding zone 322, and a trimming zone 324. In an embodiment, the plurality of molds 310 may include a first mold 310a, a second mold 310b, a third mold 310c, and a fourth mold 310d. Each mold of the plurality of molds 310 may include a pair of opposing halves. The pair of opposing halves of each mold of the plurality of molds 310 may correspond to top molds 326a-326d and bottom molds 328a-328d. The top molds 326a-326d and the bottom molds 328a-328d of the plurality of molds 310 may open and close simultaneously. The structure and functionality of the plurality of molds 310 are explained later in detail in conjunction with FIGS. 4A, 4B, and 4C.

The CCM system 306 may be configured to apply pressure simultaneously on the preforming zone 312, the heating zone 314, the crystallizing zone 316, and the cooling zone 318 of the CCM system 306 during the processing of the triaxial braid fabric 304. In an embodiment, the pressure applied during the processing of the triaxial braid fabric 304 by the CCM system 306 may range between 2 to 40 bars.

The preforming zone 312 of the CCM system 306 may be configured to receive the triaxial braid fabric 304 from the first reel 302. The preforming zone 312 may be configured to apply pressure by way of the first mold 310a of the plurality of molds 310 on the triaxial braid fabric 304 to generate a preformed triaxial braid fabric. The preformed triaxial braid fabric, which has a rough shape associated with a furlable shape, exits the preforming zone 312 and moves into the heating zone 314.

The heating zone 314 of the CCM system 306 may be configured to melt the preformed triaxial braid fabric by heating at first temperature value to form a heated triaxial braid fabric. The first temperature may range between 345 degree Celsius to 420 degree Celsius. The heating zone 314 may be further configured to apply pressure on the heated triaxial braid fabric by way of the second mold 310b of the plurality of molds to change the rough shape of the heated triaxial braid fabric to a furlable shape having uniform thickness to form a reshaped triaxial braid fabric. The heating zone 314 may convert the triaxial braid fabric 304 to a curved sheet having uniform thickness. The reshaped triaxial braid fabric, which has the furlable shape, exits the heating zone 314 and moves into the crystallizing zone 316.

The crystallizing zone 316 of the CCM system 306 may be configured to crystallize the reshaped triaxial braid fabric by compressing the reshaped triaxial braid fabric at a second temperature by way of the third mold 310c of the plurality of molds to form a compressed triaxial braid fabric. The second temperature may be lower than the first temperature. The second temperature may range between 200 degree Celsius to 270 degree Celsius. The compressed triaxial braid fabric may exit the crystallizing zone 316 and moves into the cooling zone 318.

The cooling zone 318 of the CCM system 306 may be configured to stabilize the furlable shape of the compressed triaxial braid fabric by cooling the compressed triaxial braid fabric 304 by way of the fourth mold 310d at a third temperature, thereby forming a half shell of the deployable thermoplastic boom structure. The third temperature may be lower than the first temperature. The third temperature may range between 50 degree Celsius to 140 degree Celsius. In an embodiment, the furlable shape of the half shell of the deployable thermoplastic boom structure may correspond to a semi-lenticular shape. In various other embodiments, the furlable shape of the half shell of the deployable thermoplastic boom structure may correspond to one of the semi-lenticular shape, a semi-circular shape, and a half a triangular reliable and collapsible (TRAC) shape.

The pulling zone 320 may include a pulling element that may be further configured to pull the half shell of the deployable thermoplastic boom structure from the cooling zone 318 of the CCM system 306 to move a next portion of the triaxial braid fabric 304 through the CCM system 306 when each mold of the plurality of molds 310 opens simultaneously. The holding zone 322 may be configured to hold the half shell of the deployable thermoplastic boom structure to process on the next portion of the triaxial braid fabric 304 in the CCM system 306 when each mold of the plurality of molds 310 closes simultaneously, thereby continuously processing a plurality of portions of the triaxial braid fabric 304 in the CCM system 306 to form the deployable thermoplastic boom structure continuously. The pulling of the half shell of the deployable thermoplastic boom structure in the pulling zone 320 and holding the half shell of the deployable thermoplastic boom structure in the holding zone 322 may be synchronized with opening and closing of the plurality of molds 310 of the CCM system 306. In one embodiment, during the pulling of the half shell of the deployable thermoplastic boom structure, the triaxial braid is sandwiched in between release layer (either steel or kapton (polyimide)) that have a release agent applied and the sandwiched layers are then pulled by the CCM system 306 such that the release agent layer may be carrying most of the pulling load.

The trimming zone 324 may be further configured to trim the half shell of the deployable thermoplastic boom structure to remove excess material that extends beyond the furlable shape of the deployable thermoplastic boom structure. It will be apparent to a person skilled in the art that in an alternate another embodiment, trimming of the half shell of the deployable thermoplastic boom structure may be excluded from the CCM system 306 and two half shells of the deployable thermoplastic boom structure may be welded together, without deviating from the scope of the present disclosure. The trimmed deployable thermoplastic boom structure may be further reeled on the second reel 308. It will be apparent to a person skilled in the art that in an alternate embodiment, the trimmed deployable thermoplastic boom structure may be left unreeled, without deviating from the scope of the present disclosure.

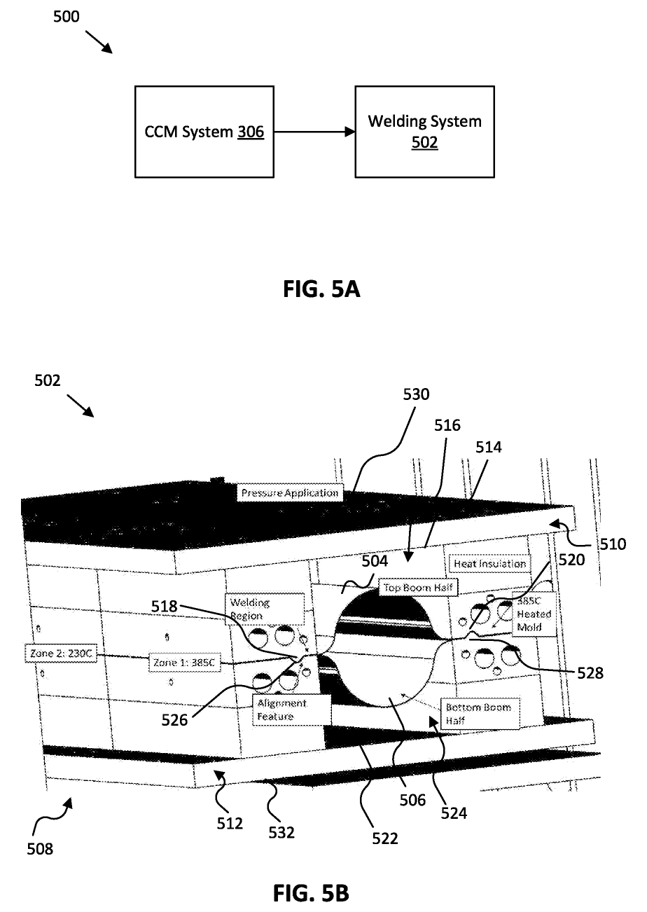

Further, two half shells of the deployable thermoplastic boom may be welded by way of a welding mold (shown later in FIG. 5B), thereby forming the deployable thermoplastic boom structure having a furlable shape. In an embodiment, the furlable shape of the deployable thermoplastic boom structure may correspond to a lenticular shape. In various other embodiments, the furlable shape of the deployable thermoplastic boom structure to one of the lenticular shape, a circular shape, and a TRAC shape. The triaxial braid fabric 304 may be continuously moved through the CCM system 306 to continuously form the deployable thermoplastic boom structure. The welding system is explained later in detail in conjunction in FIGS. 5A and 5B. The deployable thermoplastic boom structure may be further implemented on the satellite.

FIG. 4A is a simplified diagram illustrating a mold 400 which may be utilized for manufacturing the deployable boom structure in which aspects of the technology may be employed. In one embodiment, to properly align the first half shell of the deployable thermoplastic boom structure and the second half shell of the deployable thermoplastic boom structure during welding, the CCM system 306 may utilize the mold 400 as first through fourth molds 310a-310d of the plurality of molds 310. The mold 400 may include a top mold 402 and a bottom mold 404.

The top mold 402 may include a bottom surface 406. The bottom surface 406 of the top mold 402 may include a protrusion 408, a first alignment element 410, and a second alignment element 412. The protrusion 408 may extend from the bottom surface 406 of the top mold 402. The protrusion 408 may have a first shape to mold a first half shell of a deployable boom structure in a furlable shape. In an embodiment, the first shape of the protrusion 408 may correspond to a semi-lenticular shape. In various other embodiments, the first shape of the protrusion 408 may correspond to one of the semi-lenticular shape, a semi-circular shape, and a half a TRAC shape.

The top mold 402 may include a top surface 414 and side surfaces 416. In an embodiment, the hydraulic cylinder may be configured to apply a vertical pressure on the top surface 414 of the top mold 402. The side surfaces 416 of the top mold 402 may include a first plurality of holes 418 to receive cartridge heaters to heat the top mold 402 for molding the deployable boom structure. In an embodiment, stainless steel cartridge heaters having maximum temperature of 400 degree Celsius may be utilized to heat the top mold 402. Additionally, the side surfaces 416 of the top mold 402 may include a second plurality of holes 420. The second plurality of holes 420 may correspond to dowel alignment holes for multiple mold sections. The dowel alignment holes may facilitate precise positioning and stability across the multiple mold sections.

For example, when the mold 400 may be utilized as first through fourth molds 310a-310d of the plurality of molds 310, the dowel alignment holes may facilitate precise positioning and stability across one or more zones of the CCM system 306. In an embodiment, the dowel alignment holes of the first mold 310a may include an inlet chamfer that may correspond to beveled edge at entrance of the dowel alignment holes. The inlet chamfer may facilitate proper alignment and assembly of the first through fourth molds 310a-310d of the plurality of molds 310 that may prevent sharp edges causing wear and tear over time.

The shape of the bottom mold 404 may be complimentary to a shape of the top mold 402. The bottom mold 404 may include a top surface 422. The top surface 422 of the bottom mold 404 may include a depression 424, a third alignment element 426, and a fourth alignment element 428. The depression 424 may extend from the top surface 422 of the bottom mold 404. The depression 424 may have a second shape to mold the first half shell of the deployable boom structure in a furlable shape. The second shape of the depression 424 may be complimentary to the first shape of the protrusion 408. In an embodiment, the second shape of the depression 424 may correspond to an inverted semi-lenticular shape. In various other embodiments, the second shape of the depression 424 may correspond to one of the inverted semi-lenticular shape, an inverted semi-circular shape, and an inverted half TRAC shape.

It will be understood by a person skilled in the art that the shape of the bottom mold 404 may not be perfectly complimentary to the shape of the top mold 402 such that the top and bottom molds 402 and 404 may be designed to accommodate the thickness of the deployable thermoplastic boom structure and the release layers, without deviating from the scope of the present disclosure. In one example, once the top and bottom molds 402 and 404 may be fully closed, they fit the desired consolidated triaxial braid thickness, i.e., there is uniform spacing of 0.29 mm (thickness of boom structure 0.19 mm + 0.1mm thickness of release layers).

The bottom mold 404 may include side surfaces 430. The side surfaces 430 of the bottom mold 404 may include a third plurality of holes 432 to receive cartridge heaters to heat the bottom mold 404 for molding the deployable boom structure. In an embodiment, stainless steel cartridge heaters having maximum temperature of 400 degree Celsius may be utilized to heat the bottom mold 404. Additionally, the side surfaces 430 of the bottom mold 404 may include a fourth plurality of holes 434. The fourth plurality of holes 434 may correspond to dowel alignment holes for multiple mold sections. The dowel alignment holes may facilitate precise positioning and stability across the multiple mold sections. It will be apparent to person skilled in the art that the fourth plurality of holes 434 of the bottom mold 404 may be structurally and functionally similar to the second plurality of holes 420 of the top mold 402.

FIG. 4B is a simplified diagram illustrating a cross-sectional side view of the mold 400 of FIG. 4A in which aspects of the technology may be employed. In an embodiment, the shape of the first alignment element 410 may correspond to a trapezoidal shape. In various other embodiments, the shape of the first alignment element 410 of the top mold 402 may correspond to one of the trapezoidal shape, a semi-circular shape, and a triangular shape. It will be apparent to a person skilled in the art that although in the current embodiment, the first alignment element 410 has the trapezoidal shape, in various other embodiment, the first alignment element 410 may have any suitable shape for engaging a complimentary structure, without deviating from the scope of the present disclosure. The first alignment element 410 may correspond to a ridge on the bottom surface 406 of the top mold 402.

The shape of the second alignment element 412 of the top mold 402 may be complimentary to a shape of the first alignment element 410. In an embodiment, the shape of the second alignment element 412 may correspond to an inverted trapezoidal shape. In various other embodiments, the shape of the second alignment element 412 may correspond to one of the inverted trapezoidal shape, an inverted semi-circular shape, and an inverted triangular shape.

It will be apparent to a person skilled in the art that although in the current embodiment, the second alignment element 412 has the inverted trapezoidal shape, in various other embodiment, the second alignment element 412 may have any suitable shape for engaging the complimentary structure, without deviating from the scope of the present disclosure. The second alignment element 412 may correspond to a groove on the bottom surface 406 of the top mold 402. The first alignment element 410 and second alignment element 412 may be positioned at the same distance from a center of the protrusion 408 on opposite sides of the protrusion 408 (e.g., positions marked x and y equidistant from center in FIG. 4B).

It will be understood by a person skilled in the art that the shape of the first alignment element 410 may not be perfectly complimentary to the shape of the second alignment element 412 such that the first and second alignment elements 410 and 412 may be designed to accommodate the thickness of the deployable thermoplastic boom structure and the release layers, without deviating from the scope of the present disclosure.

The shape of the third alignment element 426 of the bottom mold 404 may be complimentary to the shape of the first alignment element 410. The shape of the third alignment element 426 may be same as the shape of the second alignment element 412. In an embodiment, the shape of the third alignment element 426 may correspond to an inverted trapezoidal shape. In various other embodiments, the shape of the third alignment element 426 may correspond to one of the inverted trapezoidal shape, the inverted semi-circular shape, and the inverted triangular shape. It will be apparent to a person skilled in the art that although in the current embodiment, the third alignment element 426 has the inverted trapezoidal shape, in various other embodiment, the third alignment element 426 may have any suitable shape for engaging the complimentary structure, without deviating from the scope of the present disclosure. The third alignment element 426 may correspond to a groove on the top surface 422 of the bottom mold 404.

The shape of the fourth alignment element 428 may be complimentary to a shape of the third alignment element 426 and the shape of the second alignment element 412. The shape of the fourth alignment element 428 may be same as the shape of the first alignment element 410. In an embodiment, the shape of the fourth alignment element 428 may correspond to a trapezoidal shape. In various other embodiments, the shape of the fourth alignment element 428 of the top mold 402 may correspond to one of the trapezoidal shape, the semi-circular shape, and the triangular shape.

It will be apparent to a person skilled in the art that although in the current embodiment, the fourth alignment element 428 has the trapezoidal shape, in various other embodiment, the fourth alignment element 428 may have any suitable shape for engaging the complimentary structure, without deviating from the scope of the present disclosure. The fourth alignment element 428 may correspond to a ridge on the top surface 422 of the bottom mold 404. The third alignment element 426 and fourth alignment element 428 may be positioned at the same distance from a center of the depression 424 on opposite sides of the depression 424.

It will be understood by a person skilled in the art that the shape of the third alignment element 426 may not be perfectly complimentary to the shape of the fourth alignment element 428 such that the third and fourth alignment elements 426 and 428 may be designed to accommodate the thickness of the deployable thermoplastic boom structure and the release layers, without deviating from the scope of the present disclosure.

The top mold 402 and the bottom mold 404 may be configured to receive a thermoplastic fabric between the top mold 402 and the bottom mold 404 and mold the thermoplastic fabric into the furlable shape based on the pressure applied on the top mold 402 and the bottom mold 404. In an example, the uniform pressure that may correspond to 20 bars may be applied that provides compaction from ~0.5 mm to ~0.29 mm.

The protrusion 408 on the bottom surface 406 of the top mold 402 may be configured to engage with the depression 424 on the top surface 422 of the bottom mold 404 to mold the first half shell of the deployable boom structure in the furlable shape. The first alignment element 410 of the bottom surface 406 of the top mold 402 may be configured to engage with the third alignment element 426 of the top surface 422 of the bottom mold 404 to form a first alignment notch of the first half shell of the deployable boom structure.

The second alignment element 412 of the bottom surface 406 of the top mold 402 may be configured to engage with the fourth alignment element 428 of the top surface 422 of the bottom mold 404 to form a second alignment notch of the first half shell of the deployable boom structure. The first alignment notch may be complimentary to the second alignment notch. The first alignment notch and second alignment notch may be positioned at the same distance from a center of the first half shell of the deployable boom structure on opposite sides of the first half shell of the deployable boom structure.

Similarly, the top mold 402 and bottom mold 404 may be further configured to mold a second half shell of the deployable boom structure. The second half shell of the deployable boom structure may correspond to an inverted version of the first half shell of the deployable boom structure. In an embodiment, a shape of the first half shell of the deployable boom structure may correspond to a semi-lenticular shape and a shape of the second half shell of the deployable boom structure may correspond to an inverted semi-lenticular shape, thereby the shape of the deployable boom structure may correspond to the lenticular shape.

In various other embodiments, the shape of the first half shell of the deployable boom structure may correspond to one of the semi-lenticular shape, a semi-circular shape, and a half a TRAC shape and the shape of the second half shell of the deployable boom structure may correspond to one of the inverted semi-lenticular shape, an inverted semi-circular shape, and an inverted half a TRAC shape, thereby the shape of the deployable boom structure may correspond to one of the lenticular shape, a circular shape, and a TRAC shape. The deployable boom structure may correspond to the deployable thermoplastic boom structure.

FIG. 4C illustrates a zoomed view of the mold 400 of the FIG. 4B in which aspects of the technology may be employed. The second alignment element 412 of the bottom surface 406 of the top mold 402 may be configured to engage with the fourth alignment element 428 of the top surface 422 of the bottom mold 404 to form the second alignment notch of the first half shell of the deployable boom structure. Similarly, the first alignment element 410 of the bottom surface 406 of the top mold 402 may be configured to engage with the third alignment element 426 of the top surface 422 of the bottom mold 404 to form the first alignment notch of the first half shell of the deployable boom structure. A release foil 436 may be utilized on both sides of the thermoplastic fabric 438 to distribute pressure between imperfect molds and the thermoplastic fabric 438. The release foil 436 may facilitate smooth surface defined optical properties in space. In an embodiment, the release foil 436 may correspond to a polyimide.

FIG. 5A is another simplified diagram illustrating a system 500 for manufacturing the deployable thermoplastic boom structure in which aspects of the technology may be employed. The system 500 includes the CCM system 306 and a welding system 502. The CCM system 306 may include a plurality of molds 310. In an embodiment, the CCM system 306 may utilize the mold 400 as first through fourth molds 310a-310d of the plurality of molds 310. The plurality of molds 310 may be configured to continuously process the triaxial braid fabric 304 to generate a first half shell 504 and a second half shell 506 of the deployable thermoplastic boom structure. Each mold of the plurality of molds 310 may include a pair of opposing halves and each mold of the plurality of molds may open and closes simultaneously. The triaxial braid fabric 304 may correspond to the fabric having the braided pattern that utilizes the braid of impregnated strand.

Each of the first half shell 504 and second half shell 506 of the deployable boom structure may include a furlable shape and first and second alignment notches positioned at the same distance from a center of the first half shell 504 and second half shell 506 of the deployable thermoplastic boom structure on opposite sides of the first half shell 504 and second half shell 506 of the deployable thermoplastic boom structure. The first alignment notch may be complimentary to the second alignment notch.

In an embodiment, a shape of the first alignment notch may correspond to an inverted trapezoidal shape. In various other embodiments, the shape of the first alignment notch may correspond to one of an inverted trapezoidal shape, an inverted semi-circular shape, and an inverted triangular shape. It will be apparent to a person skilled in the art that although in the current embodiment, the first alignment notch may have the inverted trapezoidal shape, in various other embodiment, the first alignment notch may have any suitable shape for engaging the complimentary structure, without deviating from the scope of the present disclosure.

In an embodiment, a shape of the second alignment notch may correspond to a trapezoidal shape. In various other embodiments, the shape of the second alignment notch may correspond to one of a trapezoidal shape, a semi-circular shape, and a triangular shape. It will be apparent to a person skilled in the art that although in the current embodiment, the second alignment notch may have the trapezoidal shape, in various other embodiment, the second alignment notch may have any suitable shape for engaging the complimentary structure, without deviating from the scope of the present disclosure.

FIG. 5B is another simplified diagram illustrating the welding system 502 for welding the first half shell 504 and the second half shell 506 of the deployable thermoplastic boom structure generated by the CCM system 306 in which aspects of the technology may be employed. The welding system 502 may include a welding mold 508. The welding system 502 may be configured to weld the first half shell 504 and the second half shell 506 of the deployable thermoplastic boom structure generated by the CCM system 306 by way of the welding mold 508. In another embodiment, the welding system 502 may be utilized within the CCM system 306 to heat the first and second alignment notches of each half shell and weld the first half shell 504 and the second half shell 506 of the deployable thermoplastic boom structure.

In an embodiment, the welding system 502 may utilize a continuous compression process by applying heat and pressure to weld the first half shell 504 and the second half shell 506 of the deployable thermoplastic boom structure. In various other embodiments, the welding system 502 may utilize one of the continuous compression process, an induction welding, a resistive welding, hot rollers, a hot stamp welding, and an adhesive bonding, without deviating from the scope of the present disclosure.

The welding mold 508 may include a top half 510 and a bottom half 512. The top half 510 of the welding mold 508 may include a bottom surface 514 that may further include a recess region 516, a first alignment element 518, and a second alignment element 520. The bottom half 512 of the welding mold 508 may include a top surface 522 that may further include a recess region 524, a third alignment element 526, and a fourth alignment element 528. The top half 510 of the welding mold 508 may include a top surface 530 that may be utilized as a heat insulation for the welding mold 508. The bottom half 512 of the welding mold 508 may include a bottom surface 532 that may be utilized as a heat insulation for the welding mold 508.

The shape of the second alignment element 520 may be complimentary to a shape of the first alignment element 518. The shape of the fourth alignment element 528 may be complimentary to a shape of the third alignment element 526 and the shape of the second alignment element 520. The shape of the fourth alignment element 528 may be same as the shape of the first alignment element 518. The shape of the third alignment element 526 may be complimentary to the shape of the first alignment element 518. The shape of the third alignment element 526 may be same as the shape of the second alignment element 520.

It will be understood by a person skilled in the art that the shape of the bottom half 512 may not be perfectly complimentary to the shape of the top half 510 such that the top and bottom halves 510 and 512 may be designed to accommodate the thickness of the deployable thermoplastic boom structure and the release layers, without deviating from the scope of the present disclosure. In one example, once the top and bottom halves 510 and 512 may be fully closed, they fit the desired consolidated triaxial braid thickness, i.e., there is uniform spacing of 0.29 mm (thickness of boom structure 0.19 mm + 0.1mm thickness of release layers).

The first alignment element 518 may correspond to a ridge on the bottom surface 514 of the top half 510 of the welding mold 508. The second alignment element 520 may correspond to a groove on the bottom surface 514 of the top half 510 of the welding mold 508. The third alignment element 526 may correspond to a groove on the top surface 522 of the bottom half 512 of the welding mold 508. The fourth alignment element 528 may correspond to a ridge on the top surface 522 of the bottom half 512 of the welding mold 508.

The welding mold 508 may be configured to receive the first half shell 504 and second half shell 506 of the deployable thermoplastic boom structure. The welding mold 508 may be configured to align the first half shell 504 and second half shell 506 of the deployable thermoplastic boom structure based on the first and second alignment notches of the first half shell 504 and second half shell 506 of the deployable thermoplastic boom structure such that the furlable shape of the first and second half shells 504 and 506 is positioned in the recess regions 516 and 524. The welding mold 508 may be further configured to align the first half shell 504 and second half shell 506 of the deployable thermoplastic boom structure based on the first alignment element 518, the second alignment element 520, the third alignment element 526, and the fourth alignment elements 528 of the welding mold 508. The first alignment notch may be received between the first alignment element 518 and the third alignment element 526 and the second alignment notch may be received between the second alignment element 520 and the fourth alignment element 528 to align the first half shell 504 and second half shell 506 of the deployable thermoplastic boom structure.

The welding mold 508 may be further configured to apply pressure on a joining region surrounding the first and second alignment notches of the first half shell 504 and second half shell 506 of deployable thermoplastic boom structure. Additionally, the welding mold 508 may be configured to weld the joining region surrounding the first and second alignment notches of the first half shell 504 and second half shell 506 of the deployable thermoplastic boom structure to form the deployable thermoplastic boom structure. The deployable thermoplastic boom structure may be further implemented on the satellite.

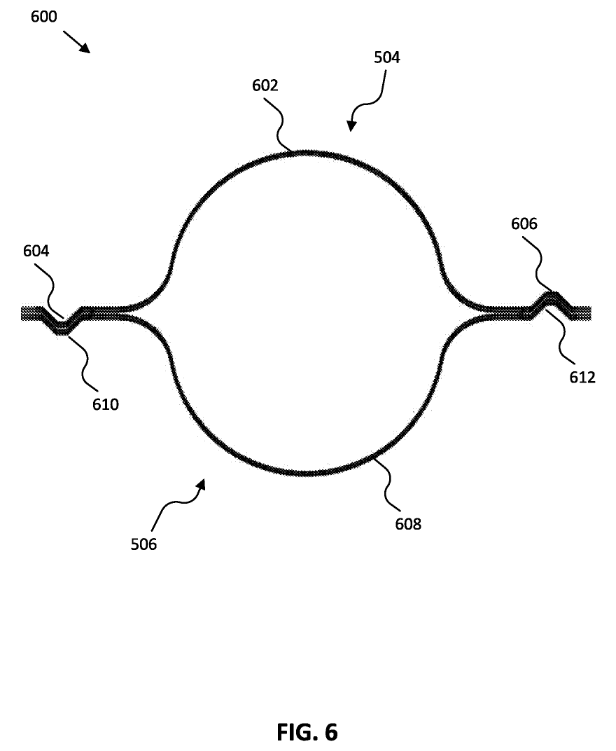

FIG. 6 illustrates the deployable thermoplastic boom structure 600 in which aspects of the technology may be employed. The deployable thermoplastic boom structure 600 may include the first half shell 504 and the second half shell 506. The first half shell 504 is having a furlable shape. The first half shell 504 may include a first curved region 602, a first alignment notch 604, and a second alignment notch 606. The first curved region 602 has one of a semi-lenticular shape, a semi-circular shape, and a half a TRAC shape. A shape of the second alignment notch 606 may be complimentary to a shape of the first alignment notch 604. The first alignment notch 604 and the second alignment notch 606 may be positioned at the same distance from a center of the first curved region 602 on opposite sides of the first curved region 602.

The second half shell 506 is having a furlable shape. A shape of the second half shell 506 may be complimentary to a shape of the first half shell 504. The second half shell 506 of the deployable thermoplastic boom structure 600 may correspond to an inverted version of the first half shell 504 of the deployable thermoplastic boom structure 600. The second half shell 506 may include a second curved region 608, a third alignment notch 610, and a fourth alignment notch 612. The second curved region 608 has one of an inverted semi-lenticular shape, an inverted semi-circular shape, and an inverted half a TRAC shape.

A shape of the fourth alignment notch 612 may be complimentary to a shape of the third alignment notch 610 and the shape of the second alignment notch 606 and same as the shape of the first alignment notch 604. A shape of the third alignment notch 610 may be complimentary to the shape of the first alignment notch 604 and same as the shape of the second alignment notch 606. The third alignment notch 610 and the fourth alignment notch 612 may be positioned at the same distance from a center of the second curved region on opposite sides of the second curved region 608.

The shape of the first alignment notch 604 and the shape of the fourth alignment notch 612 may correspond to one of an inverted trapezoidal shape, an inverted semi-circular shape, and an inverted triangular shape. The shape of the second alignment notch 606 and the shape of the third alignment notch 610 may correspond to one of a trapezoidal shape, a semi-circular shape, and a triangular shape. The first alignment notch 604 and the third alignment notch 610 may be welded together and the second alignment element 606 and the fourth alignment notch 612 may be welded together to form the deployable thermoplastic boom structure 600. The shape of the deployable boom structure 600 may correspond to one of a lenticular shape, a circular shape, and a TRAC shape respectively.

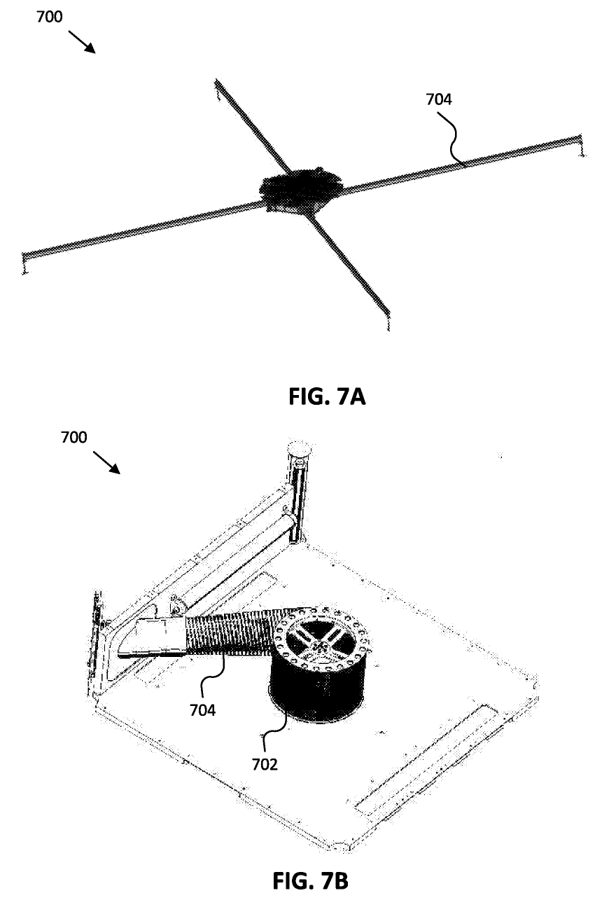

FIGS. 7A and 7B are diagrams illustrating implementation of the deployable thermoplastic boom structure for a satellite system 700 in which aspects of the technology may be employed. The satellite system 700 may include a circular hub 702 and at least one boom segment 704 of the deployable thermoplastic boom structure. The at least one boom segment 704 of the deployable thermoplastic boom structure implemented on the satellite system 700 may be manufactured utilizing one of the system 300 and the system 500. The at least one boom segment 704 may have a rolled configuration around the circular hub 702 mounted on the satellite system 700 in a stowed state, and the at least one boom segment 704 may be rolled along a widthwise axis in the rolled configuration as shown in the FIG. 7B. The at least one boom segment 704 may have a deployable configuration, and the at least one boom segment 704 may extend along a lengthwise axis in a deployed state. In an embodiment, the at least one boom segment 704 may extend outwards from a center of the satellite system 700 in the deployed state as shown in the FIG. 7A

The at least one boom segment 704 may store elastic energy in the rolled configuration and the elastic energy is released upon deployment of the at least one boom segment 704 such that the at least one boom segment 704 is impelled in the deployed state. The at least one boom segment 704 may have the furlable shape that allows the rolled configuration in the stowed state and extension in the deployed state. In an embodiment, the furlable shape of the at least one boom segment 704 may correspond to a lenticular shape. In various other embodiments, the furlable shape of the at least one boom segment 704 may correspond to one of the lenticular shape, the circular shape, and the TRAC shape.

In an embodiment, the CCM system 306 may be utilized to manufacture the deployable thermoplastic boom structure. In various other embodiments, any suitable system, such as vacuum bagging system or autoclave system, may be utilized to manufacture the deployable thermoplastic boom structure, without deviating from the scope of the present disclosure. A braided ply architecture that comprises narrow strips of the impregnated strand may be utilized as a raw material to manufacture the deployable thermoplastic boom structure. The impregnated strand may correspond to the impregnated unidirectional thermoplastic tape.

The braid of impregnated unidirectional thermoplastic tape may include the first tape 202 having the first orientation, the second tape 204 having the second orientation different than the first orientation, the third tape 206 having the third orientation different than the first and second orientations. The third orientation may be opposite of the first orientation. The first tape 202 may have the first orientation that may correspond to +45 degrees, the second tape 204 may have the second orientation that may correspond to zero degrees, and the third tape 206 may have the third orientation that may correspond to -45 degrees.

The first through third tapes 202, 204, 206 are braided together to form the braid of impregnated unidirectional thermoplastic tape. The first through third tapes 202, 204, 206 are braided together such that the architecture of the braid of impregnated unidirectional thermoplastic tape may include the first portion having the first layer of the first tape 202, the second layer of the second tape 204, and the third layer of the third tape 206. The second portion having the first layer of the first tape 202 and the second layer of the third tape 206. The third portion having the first layer of the third tape 206, the second layer of the second tape 204, and the third layer of the first tape 202. The fourth portion having the first layer of the third tape 206 and the second layer of the first tape 202.

Utilization of thermoplastic may help to increase the throughput of the deployable thermoplastic boom structure to fifteen meters per hour that may allow to manufacture twenty-four times more booms per day as compared to the conventional methods. In one example, the deployable thermoplastic boom structures may have thicknesses of around 100-600 micrometers and may extend to lengths of up to 20 meter. The CCM system 306 may facilitate high-rate and automated large-scale manufacturing of thin, lightweight, and large composite spacecraft structures, thereby eliminating the hand labor. The manufacturing method may facilitate unwinding and aligning the raw material continuously eliminating prior hand labor during manufacturing. The manufacturing method may utilize thin braids of impregnated unidirectional thermoplastic tape to achieve symmetric composite layup architectures that utilizes one of single ply or double plies, thereby achieving minimal thickness, axial stiffness, and off-axis strength.

The architectures may be coupled with the CCM system 306, which facilitates thin, continuous cross-sections of spacecraft booms at infinite length, large manufacturing rates of foldable and low thermal expansion spacecraft booms eliminating the requirement for large ovens and increasing mechanical performance and resistance to radiation and atomic oxygen. An overall shell of the deployable thermoplastic boom structure eliminates the requirement for multiple layers for achieving symmetry facilitating utilization of thicker input material for the triaxial braid, for example two to three times thick, as compared to the input material utilized in the conventional methods. Utilization of thicker thermoplastics may facilitate the continuous manufacturing of the raw material and mitigates the impact of the limited availability of raw material in the conventional methods. The thermoplastic input material may have ability to be molten and reshaped in short span of time utilizing continuous compression molding process.

Utilization of thermoplastic triaxial braids may facilitate rapid manufacturability of ultra-light weight thermoplastic spacecraft booms that may compete with performance of the thermoset booms. Boom aerial weights of 170 gram per meter square and lower may be achievable by utilizing thermoplastic triaxial braids.

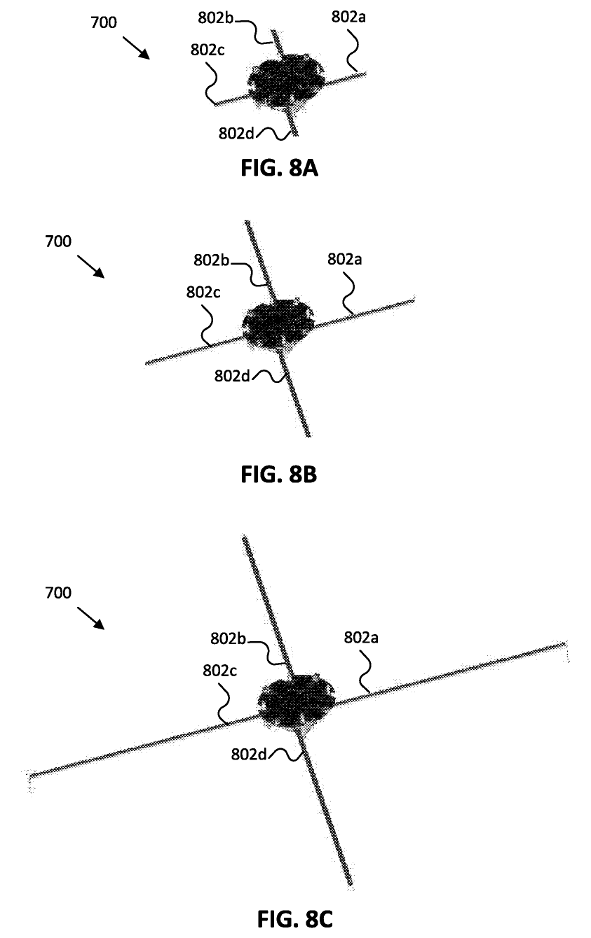

FIGS. 8A-8C are diagrams illustrating deploying of the deployable thermoplastic boom structure for the satellite system 700 in which aspects of the technology may be employed. The satellite system 700 may include first through fourth boom segments 802a-802d of the deployable thermoplastic boom structure. manufactured utilizing one of the system 300 and the system 500. The first through fourth boom segments 802a-802d may have a rolled configuration around the circular hub 702 mounted on the satellite system 700 in a stowed state. The first through fourth boom segments 802a-802d may have a deployable configuration, and the first through fourth boom segments 802a-802d may extend along a lengthwise axis in a deployed state. In an embodiment, the first through fourth boom segments 802a-802d may extend outwards from a center of the satellite system 700 in the deployed state as shown in the FIGS. 8A-8C.

Referring to FIG. 8A, the first through fourth boom segments 802a-802d may store elastic energy in the rolled configuration and the elastic energy is released upon deployment of the first through fourth boom segments 802a-802d such that the first through fourth boom segments 802a-802d are impelled in the deployed state and initiate to transform from a stowed state to a deployed state. Referring to FIG. 8B, the first through fourth boom segments 802a-802d may have been deployed halfway. Referring to FIG. 8C, the first through fourth boom segments 802a-802d may have been completely deployed. It will be apparent to a person skilled in the art that the first through fourth boom segments 802a-802d may transform from the deployed state to the stowed state in a reverse order of deployment by rolling up around the circular hub 702.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. An apparatus, the apparatus comprising:
a top mold comprising a bottom surface that comprises:
a protrusion having a first shape to mold a first half shell of a deployable boom structure in a furlable shape;
a first alignment element; and
a second alignment element, wherein a shape of the second alignment element is complimentary to a shape of the first alignment element, and wherein the first and second alignment elements are positioned at the same distance from a center of the protrusion on opposite sides of the protrusion; and
a bottom mold, wherein a shape of the bottom mold is complimentary to a shape of the top mold, and wherein the bottom mold comprises a top surface that comprises:
a depression having a second shape to mold the first half shell of the deployable boom structure in a furlable shape, wherein the second shape is complimentary to the first shape;
a third alignment element; and
a fourth alignment element, wherein:
a shape of the fourth alignment element is (i) complimentary to a shape of the third alignment element and the shape of the second alignment element and (ii) same as the shape of the first alignment element,
a shape of the third alignment element is (i) complimentary to the shape of the first alignment element and (ii) same as the shape of the second alignment element, and
the third and fourth alignment elements are positioned at the same distance from a center of the depression on opposite sides of the depression.

2. The apparatus of claim 1, wherein:
the first shape corresponds to one of a semi-lenticular shape, a semi-circular shape, and a half triangular reliable and collapsible (TRAC) shape; and
the second shape corresponds to an inverted semi-lenticular shape, an inverted semi-circular shape, and an inverted half TRAC shape.

3. The apparatus of claim 1, wherein:
the shape of the first alignment element and the shape of the fourth alignment element corresponds to one of a trapezoidal shape, a semi-circular shape, and a triangular shape; and
the shape of the second alignment element and the shape of the third alignment element corresponds to one of an inverted trapezoidal shape, an inverted semi-circular shape, and an inverted triangular shape.

4. The apparatus of claim 1, wherein:
the first alignment element corresponds to a ridge on the bottom surface of the top mold; and
the second alignment element corresponds to a groove on the bottom surface of the top mold.

5. The apparatus of claim 1, wherein:
the third alignment element corresponds to a groove on the top surface of the bottom mold; and
the fourth alignment element corresponds to a ridge on the top surface of the bottom mold.

6. The apparatus of claim 1, wherein:
the protrusion on the bottom surface of the top mold is configured to engage with the depression on the top surface of the bottom mold to mold the first half shell of the deployable boom structure in a furlable shape.

7. The apparatus of claim 1, wherein:
the first alignment element is configured to engage with the third alignment element to form a first alignment notch of the first half shell of the deployable boom structure; and
the second alignment element is configured to engage with the fourth alignment element to form a second alignment notch of the first half shell of the deployable boom structure, wherein the first alignment notch is complimentary to the second alignment notch, and wherein the first and second alignment notches are positioned at the same distance from a center of the first half shell of the deployable boom structure on opposite sides of the first half shell of the deployable boom structure.

8. The apparatus of claim 1, wherein the top and bottom molds are configured to receive a thermoplastic fabric between the top and bottom molds and mold the thermoplastic fabric into the furlable shape based on the pressure applied on the top and bottom molds.

9. The apparatus of claim 1, wherein the top mold and the bottom mold comprise a first plurality of holes and a second plurality of holes to receive cartridge heaters to heat the top and bottom molds, respectively, for molding the deployable boom structure.

10. The apparatus of claim 1, wherein the top and bottom molds are configured to mold a second half shell of the deployable boom structure.

11. The apparatus of claim 10, wherein the second half shell of the deployable boom structure corresponds to an inverted version of the first half shell of the deployable boom structure.

12. The apparatus of claim 10, wherein a shape of the first half shell of the deployable boom structure corresponds to one of a semi-lenticular shape, a semi-circular shape, and a half TRAC shape and a shape of the second half shell of the deployable boom structure corresponds to one of an inverted semi-lenticular shape, an inverted semi-circular shape, and an inverted half TRAC shape, thereby a shape of the deployable boom structure corresponds to one of a lenticular shape, a circular shape, and a TRAC shape respectively .

13. The apparatus of claim 1, wherein the deployable boom structure corresponds to a deployable thermoplastic boom structure.

14. A deployable thermoplastic boom structure, comprising:
a first half shell having a furlable shape, the first half shell comprising:
a first curved region;
a first alignment notch; and
a second alignment notch, wherein a shape of the second alignment notch is complimentary to a shape of the first alignment notch, and wherein the first and second alignment notches are positioned at the same distance from a center of the first curved region on opposite sides of the first curved region; and
a second half shell having a furlable shape, wherein a shape of the second half shell is complimentary to a shape of the first half shell, and wherein the second half shell comprises:
a second curved region;
a third alignment notch; and
a fourth alignment notch, wherein:
a shape of the fourth alignment notch is (i) complimentary to a shape of the third alignment notch and the shape of the second alignment notch and (ii) same as the shape of the first alignment notch,
a shape of the third alignment notch is (i) complimentary to the shape of the first alignment notch and (ii) same as the shape of the second alignment notch,
the third and fourth alignment notches are positioned at the same distance from a center of the second curved region on opposite sides of the second curved region, and
the first and third alignment notches are welded together and the second and fourth alignment notches are welded together to form the deployable thermoplastic boom structure.

15. The deployable thermoplastic boom structure of claim 14, wherein:
the first curved region has one of a semi-lenticular shape, a semi-circular shape, and a half triangular reliable and collapsible (TRAC) shape; and
the second curved region has one of an inverted semi-lenticular shape, an inverted semi-circular shape, and an inverted half TRAC shape.

16. The deployable thermoplastic boom structure of claim 14, wherein:
the shape of the first alignment notch and the shape of the fourth alignment notch corresponds to one of an inverted trapezoidal shape, an inverted semi-circular shape, and an inverted triangular shape; and
the shape of the second alignment notch and the shape of the third alignment notch corresponds to one of a trapezoidal shape, a semi-circular shape, and a triangular shape.

17. The deployable thermoplastic boom structure of claim 14, wherein the second half shell of the deployable thermoplastic boom structure corresponds to an inverted version of the first half shell of the deployable thermoplastic boom structure.

18. The deployable thermoplastic boom structure of claim 14, a shape of the deployable boom structure corresponds to one of a lenticular shape, a circular shape, and a TRAC shape respectively.
